(19) United States
(12) Patent Application Publication
(10) Pub. No.: US 2010/0195672 A1
(43) Pub. Date: Aug. 5, 2010

(54) DIAGNOSIS OF THE SYNCHRONIZATION OF TWO COMMUNICATIONS NETWORKS OF AN ELECTRONIC DATA-PROCESSING SYSTEM

(76) Inventors: Juergen Schirmer, Heidelberg (DE); Andreas-Juergen Rohatschek, Wernau/Neckar (DE); Harald Weiler, Goeppingen (DE); Clemens Schroff, Kraichtal (DE); Thomas Hogenmueller, Palo Alto, CA (US)

Correspondence Address: KENYON & KENYON LLP, ONE BROADWAY, NEW YORK, NY, 10004, US

(21) Appl. No.: 12/621,289

(22) Filed: Nov. 18, 2009

(30) Foreign Application Priority Data
Feb. 3, 2009 (DE) 10 2009 000 584.6

(51) Int. Cl. H04J 3/06

(52) U.S. Cl. 370/503

(57) ABSTRACT

A method for diagnosing a synchronization of two communications networks of an electronic data-processing system, each communications network including at least one node and having a respective schedule that specifies at least one respective time slot for a respective synchronization message, may include detecting, by each of the two communications networks, an individual time-based variable, comparing the two detected time-based variables to each other, and determining a quality of the synchronization of the two communications networks based on the comparison.

### FIELD OF THE INVENTION

The present invention relates to a method, electronic diagnosis device, and electronic data-processing system for diagnosing a synchronization of two communications networks.

### BACKGROUND INFORMATION

In an electronic data-processing system of a motor vehicle, for example, a plurality of control devices are interconnected via one or more communications networks of the data-processing system. The communications networks may be bus-type or star-shaped systems, for instance. The control devices are provided to perform specific functions, such as fuel-injection, steering, or braking functions of the motor vehicle.

If, for example, two so-called event-driven communications networks are provided, then it is known to interconnect these communications networks with the aid of a so-called gateway. The gateway is responsible for converting and possibly buffer-storing the data transmitted following what is referred to as an interrupt on the first communications network, such that these data are then able to be forwarded to the second communications network and transmitted from there. This conversion and buffer-storage entails time delays in forwarding the data from the first communications network to the second communications network.

In what is called a time-controlled communications network, there exists a fixedly specified flow chart, known as a schedule, which assigns to each connected control device a specific time slot during which this control device may transmit data via the communications network. The schedule also specifies at least one time slot containing a synchronization message, with whose aid all control devices connected to the communications network are able to synchronize with each other as a function of time.

### SUMMARY OF THE INVENTION

If two time-controlled communications networks are provided which are to be coupled to one another, then the two communications networks should also be synchronized with one another as a function of time. Monitoring the synchronization is advantageous in order to ensure a correct method of functioning. An object of the present invention is a diagnosis of the synchronization of two communications networks of an electronic data-processing system, which objective may be achieved by a method, device, and/or data-processing system according to example embodiments of the present invention.

For the diagnosis of the synchronization of two communications networks of an electronic data-processing system according to an example embodiment of the present invention, each of the two communications networks detects an individual time-based variable, the two detected time-based variables are compared to one another, and a quality of the synchronization of the two communications networks is inferred from the comparison.

In an example embodiment of the present invention, the synchronization messages on the two communications networks may be utilized as time-based variables. The time interval of these synchronization messages on the two communications networks then represents the quality of the synchronization. This value of the time interval may subsequently be compared with a specified performance index. If the determined time interval exceeds the associated specified performance index, then an error message may be derived therefrom.

### BRIEF DESCRIPTION OF THE DRAWINGS

The drawings illustrate generally, by way of example, but not by way of limitation, example embodiments of the present invention discussed in detail in the following description, from which description additional features, applications, and advantages of the present invention will be apparent.

FIG. 1 is a schematic circuit diagram of an example embodiment of the present invention in which there is a diagnosis of synchronization of two communications networks.

FIG. 2 shows schematic time diagrams relating to the aforementioned synchronization of two communications networks.

### DETAILED DESCRIPTION

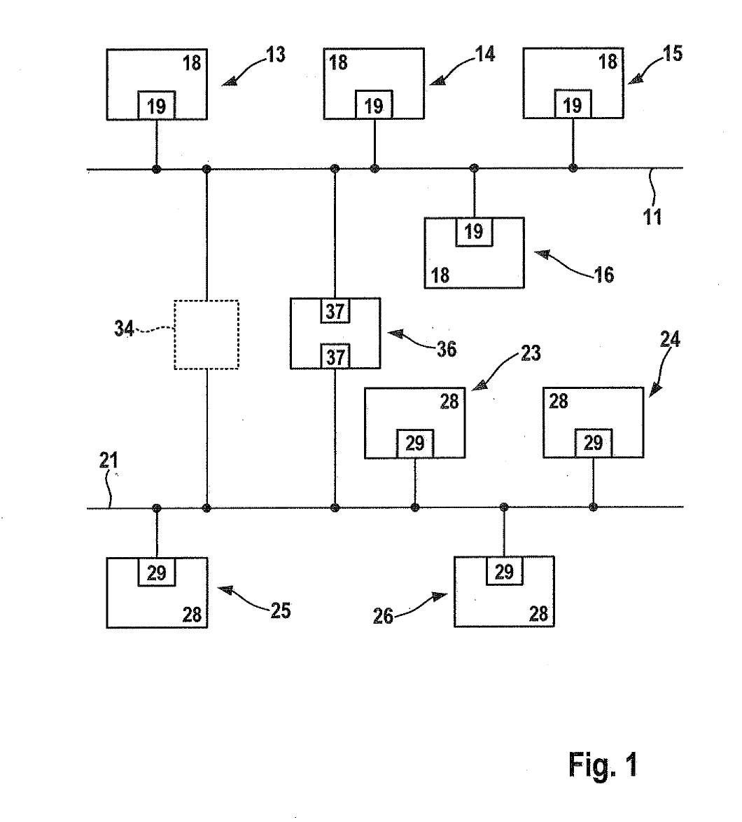

FIG. 1 shows a first bus 11 of an electronic data-processing system according to an example embodiment of the present invention, which may be any type of time-controlled communications network. For example, bus 11 may be realized as a so-called FlexRay bus or as a so-called TTCAN (Time Triggered CAN)-bus. Bus 11 is provided for the transmission of digital data especially in a motor vehicle.

Four nodes 13, 14, 15, 16 have been connected to bus 11 by way of example. A node, for instance, may be a component of a control device, which control device is able to carry out one or a plurality of functions, e.g., functions with regard to the injection of fuel into an internal combustion engine, steering functions, and/or braking functions of a motor vehicle.

In an example embodiment, each node 13, 14, 15, 16 has a communications controller 18 and a bus transceiver 19. Bus transceiver 19 establishes the direct connection of the associated node with bus 11 by writing to bus 11, or by reading from bus 11, electrical signals representing the digital data to be transmitted. Communications controller 18 implements a specified flow chart, which is known as a schedule.

The schedule subdivides the transmission time available on the bus into successive cycles, each of which includes a plurality of time slots, among other things. Each time slot can accommodate one message, a referred to as a frame, and each message contains, among other things, a number of data items to be transmitted, which is known as a payload.

The schedule assigns to each node 13, 14, 15, 16 at least one specific time slot for transmitting and/or receiving digital data in the successive cycles, so that each, or at least one, of nodes 13, 14, 15, 16 is able to write to bus 11 a number of digital data items, and thus is able to transmit them via bus 11. Preferably, a plurality of time slots per cycle is assigned to the individual nodes 13, 14, 15, 16.

For the temporal synchronization of nodes 13, 14, 15, 16, the schedule specifies that at least one of nodes 13, 14, 15, 16 transmits a synchronization message in one of the specific time slots available to it in the successive cycles. Such synchronization messages are preferably transmitted by a plurality of nodes 13, 14, 15, 16 within the time slots available to them. Thus, one or a plurality of synchronization messages is available on bus 11 in each cycle.

The schedule is known to all nodes 13, 14, 15, 16. Thus, all nodes 13, 14, 15, 16 “know” in which time slots the synchronization messages are transmitted on bus 11.

The individual time slots of the schedule are determined in each node 13, 14, 15, 16 based on a time basis which is a function of a quartz oscillator, for example. Since the time bases available to individual nodes 13, 14, 15, 16 may deviate from each other, for instance because of different quartzes, it may occur that one of the other nodes is unable to precisely determine the particular time slot in which a synchronization message is written to bus 11 by a certain node, but instead determines it only with a slight deviation.

Because the deviation is only slight and because the schedule always provides, between the messages of two successive time slots, an interval in which no data are transmitted, the aforementioned other node is able to read in the synchronization message of the particular node via its bus transceiver 19 despite the slight deviation. The other node can then determine the mentioned deviation as a function of the read-in synchronization message and compensate for it by correcting its time base. The other node is therefore able to synchronize itself to the read-in synchronization message.

Overall, all nodes 13, 14, 15, 16 connected to bus 11 are able to synchronize themselves with each other with the aid of the transmitted synchronization messages.

The data-processing system of FIG. 1 includes a second bus 21, which is comparable to bus 11 or corresponds to bus 11, and which may be any type of time-controlled communications network. For example, bus 21 may be realized as a so-called FlexRay bus or as a so-called TTCAN bus. Four nodes 23, 24, 25, 26 have been connected to bus 21 by way of example. Nodes 23, 24, 25, 26 are comparable to nodes 13, 14, 15, 16 of bus 11 and may be part of a control device, for example. Each node 23, 24, 25, 26 of bus 21 may be provided with a communications controller 28 and a bus transceiver 29, which in turn are comparable to communications controller 18 and bus transceiver 19 of bus 11.

The method of functioning of nodes 23, 24, 25, 26 may correspond to the method of functioning of nodes 13, 14, 15, 16. In particular, the definition of cycles and time slots with the aid of a schedule for nodes 23, 24, 25, 26 of second bus 21 is provided in the same way it is for nodes 13, 14, 15, 16.

The two buses 11, 21 are coupled to one another. This is indicated by dashed link 34 in FIG. 1. Any suitably appropriate hardware and/or software design may be used for the link 34. Link 34 may be a gateway, for instance. Furthermore, the two buses 11, 21 are mutually synchronized. Any suitably appropriate method and/or hardware- and/or software-based synchronization arrangement may be used for this synchronization.

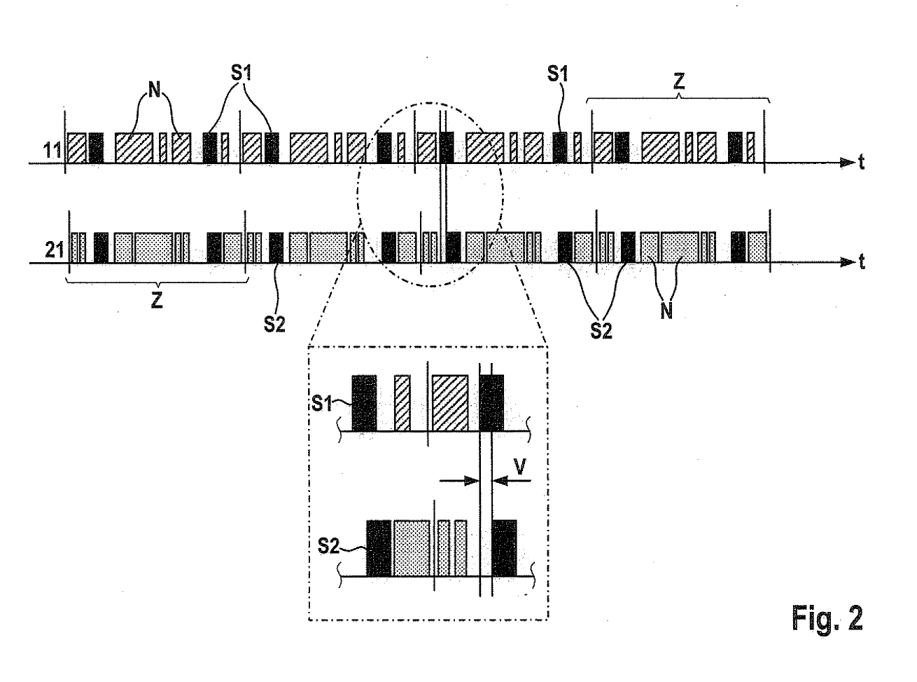

In FIG. 2, the messages transmitted on the two buses 11, 21 of the data-processing system, according to an example embodiment, are plotted over time t. The upper diagram relates to first bus 11, and the lower diagram to second bus 21. The circled area of the two diagrams is shown once more in enlarged form underneath.

The cycles defined by the schedules are denoted by reference numeral Z in the two diagrams. The time slots are not shown. Shown instead are the messages transmitted in the individual time slots. These messages are denoted by reference numeral N. Provided between the messages are the mentioned pauses during which no data are transmitted.

The synchronization messages present on first bus 11 are denoted by reference numeral S1 in the upper diagram. The synchronization messages present on second bus 21 are denoted by reference numeral S2 in the lower diagram.

As can be gathered from the enlarged illustration in particular, there may be a time delay, denoted by reference numeral V, between one of synchronization messages S1 of first bus 11 and associated synchronization message S2 of the second bus.

According to FIG. 1, the two buses 11, 21 are connected to a diagnosis device 36, which may include hardware and/or software. Diagnosis device 36 may be provided as a separate device or may be partially or completely integrated in one or a plurality of provided nodes 13, 14, 15, 16, 23, 24, 25, 26 of the two buses 11, 21 or in a gateway or in a hardware of the bus topology.

In an example embodiment of the present invention, diagnosis device 36 includes a time-acquisition arrangement 37, with whose aid one or a plurality of time-based variables is able to be determined on the two connected buses 11, 21. The time-based variables may be, for example, synchronization messages S1, S2 on the two buses 11, 21, such as the rising flank of these signals, for example. As an alternative, it may involve other signals occurring on the two buses 11, 21 at predetermined instants. In the same way, it may be not only the rising flank from which the time-based variables are derived but other characteristic criteria of these signals as well. Other possibilities for the time-based variables include specific characteristic quantities of the transmitted data, e.g., specific time stamps or the like.

In an example embodiment, it is assumed that diagnosis device 36 detects the rising flanks of synchronization messages S1, S2 on the two buses 11, 21. These two time-based variables are then compared to each other by diagnosis device 36. From this comparison, diagnosis device 36 thereupon determines an item of time information that characterizes the quality of the synchronization of the two buses 11, 21.

With regard to the comparison, it is possible that diagnosis device 36 determines the time interval of the two detected time-based variables. According to FIG. 2, this corresponds to time delay V of the two synchronization messages S1, S2. This time interval may then be compared with a specified performance index. If the determined time interval exceeds the specified performance index, then diagnosis device 36 is able to generate an error message, for instance, which indicates to the nodes 13, 14, 15, 16, 23, 24, 25, 26 connected to the two buses 11, 21 a synchronization of the two buses 11, 21 that does not correspond to the specifications.

In an example embodiment, the diagnosis device 36 determines a temporal change of the mentioned time information. Accordingly, successive time information may be differentiated. Using a comparison with a specified performance criterion, it is then possible to ascertain dynamic changes in the synchronization of the two buses 11, 21 and possibly notify connected nodes 13, 14, 15, 16, 23, 24, 25, 26.

In an example embodiment of the present invention, the diagnosis device 36 forms an average value or integration across successive time information. Dynamic changes of the synchronization, in particular, may then be determined via another comparison with specified performance criteria.

Thus, deviations in the synchronization of the two buses 11, 21 from specified performance criteria are able to be determined with the aid of diagnosis device 36. Furthermore, diagnosis device 36 may forward these deviations to connected nodes 13, 14, 15, 16, 23, 24, 25, 26 and possibly to other devices of the two buses 11, 21 as well. There, it may then be ensured that the deviations do not lead to any operational interruptions of the functions running on nodes 13, 14, 15, 16, 23, 24, 25, 26.

In addition, the deviations may be utilized for taking corresponding counter measures, with whose aid these deviations of the synchronization are then able to be reduced again.

The above description is intended to be illustrative, and not restrictive. Those skilled in the art can appreciate from the foregoing description that the present invention may be implemented in a variety of forms, and that the various embodiments and described features may be implemented alone or in combination, regardless of how they are combined and/or formulated in the above description, drawings, and/or in the following claims. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A method for diagnosing a synchronization of two communications networks of an electronic data-processing system, each of the communications networks including at least one respective node and having a respective schedule that specifies at least one time slot for a respective synchronization message, the method comprising:
detecting, by each of the communications networks, a respective time-based variable;
comparing the detected time-based variables to each other; and
determining a quality of the synchronization of the two communications networks based on the comparison.

2. The method as recited in claim 1, further comprising:
obtaining a value as a result of the comparison; and
comparing the value to a performance index.

3. The method as recited in claim 2, further comprising:
generating an error message when the value is greater than the performance index.

4. The method as recited in claim 1, wherein the synchronization messages are used as the time-based variables.

5. A hardware computer-readable medium having stored thereon instructions, the instructions which when executed, cause a processor to perform a method for diagnosing a synchronization of two communications networks of an electronic data-processing system, each of the communications networks including at least one respective node and having a respective schedule that specifies at least one time slot for a respective synchronization message, the method comprising:
detecting, by each of the communications networks, a respective time-based variable;
comparing the detected time-based variables to each other; and
determining a quality of the synchronization of the two communications networks based on the comparison.

6. An electronic diagnosis device to which two communications networks are connected, each of the communications networks including at least one respective node and having a respective schedule that specifies at least one time slot for a respective synchronization message, the electronic diagnosis device comprising:
an arrangement configured to:
obtain a respective time-based variable detected, respectively, by each of the communications networks;
compare the obtained time-based variables to each other; and
determine a quality of the synchronization of the two communications networks based on the comparison.

7. The diagnosis device as recited in claim 6, wherein a value is obtained as a result of the comparison, and the value is compared to a performance index.

8. The diagnosis device as recited in claim 7, wherein the arrangement is configured to generate an error message when the value is greater than the performance index.

9. The diagnosis device as recited in claim 6, wherein the synchronization messages are used as the time-based variables.

10. A data-processing system, comprising:
two communications networks, each (a) including at least one respective node, (b) having a respective schedule that specifies at least one time slot for a respective synchronization message, and (c) detecting a respective time-based variable; and
a diagnosis device configured to:
compare the obtained time-based variables to each other; and
determine a quality of the synchronization of the two communications networks based on the comparison.

11. The data-processing system as recited in claim 10, wherein the two communications networks are time-controlled communications networks.

12. The data-processing system as recited in claim 11, wherein the time-controlled communications networks are FlexRay or TTCAN buses.

13. The data-processing system as recited in claim 10, wherein each of at least one of the nodes is a component of a control device, at least one function in a motor vehicle being executable by the control device.

14. The data-processing system as recited in claim 13, wherein the at least one function includes at least one of a function for injection of fuel into an internal combustion engine of the motor vehicle, a steering function of the motor vehicle, and a braking function of the motor vehicle.
